(19) United States
(12) Patent Application Publication
(10) Pub. No.: US 2011/0056786 A1
(43) Pub. Date: Mar. 10, 2011

(54) Electrically Controlled Brake

(75) Inventors: Lennart Stridsberg, Stockholm (SE); Fredrik Rooth, Knivsta (SE)

(73) Assignee: STRIDSBERG INNOVATION AB, Stockholm (SE)

(21) Appl. No.: 12/812,209

(22) PCT Filed: Jan. 19, 2009
(86) PCT No.: PCT/SE09/00020

§ 371 Date: Nov. 12, 2010

(30) Foreign Application Priority Data
Jan. 19, 2008 (SE) 0800126-5

(51) Int. Cl. F16D 65/27; F16D 51/10

(52) U.S. Cl. 188/325; 188/342

(57) ABSTRACT

An electrically controlled brake includes a rotatable first mechanical system and a second mechanical system that is stationary or fixed. The two systems have friction surfaces/parts that can be made to come in engagement with each other, providing a braking effect, and be withdrawn from each other releasing the braking effect. In the second system, windings can be wound around two braking shoes made from soft magnetic material so that an electric current flowing in the windings affects magnetic fluxes through the soft magnetic parts to move at least one thereof. The movement is in a direction that affects the effective width of an air gap in the closed main magnetic path. The electric current gives attraction forces over the air gap which tend to move the braking shoes to reduce the length of the air gap. A spring that e.g. can be a flat spring is rigidly mounted to inner ends of the braking shoes, creating forces on the braking shoes acting in a direction substantially opposite that of the attraction forces. The spring and the braking shoes form a unified structure that via a portion of the spring is rigidly attached to a stationary component of the brake, such as through a bar. Since the movements of the braking shoes are not performed about some shaft or articulation, there is no mechanical play in the brake.

### RELATED APPLICATIONS

This application claims priority and benefit from Swedish patent application No. 0800126-5, filed Jan. 19, 2008, the entire teachings of which are incorporated herein by reference. The application is based on technology disclosed in published International patent application WO 2007/139480 and the corresponding U.S. patent application, the entire teachings of which are also incorporated herein by reference.

### TECHNICAL FIELD

The present invention is concerned with brakes, in particular holding brakes for servo motors.

### BACKGROUND

Servo motors brakes are often used in applications where it is important that they will not move when the servo motor is disengaged. Servo motors are often used in applications, such as positioning, with a high fraction of the operating time maintaining a fixed position, i.e. staying at a stationary position. To save unnecessary heating of such a motor, a brake used for maintaining the position should be active during such intervals and the servo motor passive. This requires that the brake has a very limited play.

Spring loaded brakes are normally designed including a friction disc that is connected to the motor shaft over splines. This gives an unwanted play between the brake friction disc and the motor shaft. Such brakes used in servo motors are normally designed to be normally engaged and permitting the shaft to move only when a release electromagnet is energised.

The British patent 989,868 discloses a spring loaded drum brake that has two friction surface carrying shoes 1 and 2 connected to the brake frame over a common pin 3. The play between shoes and pin will give a play in the position of the brake drum when torques of different magnitudes and signs act on the drum.

The published International patent application WO 2007/139480 discloses embodiments of a brake assembled inside a hollow rotor and including a toroidal soft magnetic part. These embodiments all have some play between the toroidal soft magnetic parts and the brake stator, permitting the shaft of the brake to have a play against the brake stator when the brake is in an activated state.

### SUMMARY

It is an object of the invention to provide a brake that has its mechanically critical dimension tolerances in the radial direction, thereby utilising that radial dimensions are less expensive to achieve with a high precision than axial dimensions.

It is another object of the invention to provide a brake in which the magnetic property of toroidal cores is used to obtain a more efficient brake.

It is another object of the invention is to provide a brake having a high torque to power loss ratio.

It is yet another object of the invention to provide a brake having negligible play.

Generally, an electrically controlled brake for use in a motor, e.g. an electric motor or server motor, includes a first mechanical system or first group of components which is mounted to rotate about an axis and which its main component includes a braking drum that has an inner cylindrical wall or surface. Also, the brake includes a second mechanical system or second group of components. In the second system or group the components can be more or less stationary or fixed, at a maximum performing e.g. only relative small movements. There is at least one winding to which a control electric current can be applied. At least one movable braking shoe has a friction part for acting against or for engagement with the inner cylindrical wall or surface of the braking drum. The braking shoe is made from magnetically soft iron material and is arranged so that electric current flowing in the winding affects magnetic fluxes through the braking shoe. Such magnetic fluxes cause attraction forces over a first air gap and thereby they attempt or tend to move the braking shoe to reduce the width of the air gap. Furthermore, the second system or group includes at least one spring that is mounted to create elastic forces acting on the at least one movable braking shoe. The elastic forces act in a direction so that they substantially oppose the attraction forces over the airgap created by an electrical current flowing in the winding. The elastic forces also attempt or tend to move the braking shoe so that the friction part thereof is moved to come in engagement with the inner wall or surface of the braking drum. The attraction forces instead attempt or tend to move the braking shoe so that the friction part is moved to be free of or relieved from engagement with the inner wall or surface of the braking drum.

The spring can be mounted so that in the movement of the braking shoe there is no mechanical play. Mechanical play is here taken to mean that, since the braking shoe must be connected to one of the completely stationary or fixed components in order to perform a braking action when its friction part or braking lining is brought in contact with the inner wall or surface of the braking drum, this connection must be without play. For achieving this the spring can be mounted at an inner end of the braking shoe and then the first airgap can be located at an outer, opposite end of the braking shoe. Furthermore, the spring can be rigidly attached to the inner end of the at least one movable braking shoe so that the spring and the braking shoe forms a unified structure. The spring then has a free portion which is not attached to the braking shoe and not attached to any completely fixed or stationary component and which can be elastically deformed. The free portion can be called a bridge portion and it can be flexed or perform a simple bending movement when the movable braking shoe moves. Such a flexing or simple bending movement means that the bridge portion in deformed in substantially one single plane.

Two movable braking shoes can be arranged, both having inner ends at the spring and outer ends at the first airgap. Then the spring acts at said inner ends and can be rigidly attached to them so that the spring and the two braking shoes form a unified, generally C-shaped structure. The first airgap is then located at the free ends of the C-shape and the spring at the central position between the free ends. Then the spring forms a bridge between the inner ends of the two braking shoes where the bridge can include one or more bridge portions that are located between said inner ends and are flexed or perform a simple bending movement when the two movable braking shoes move.

The spring can have a substantially flat shape, i.e. have the shape of a plate. Such a flat spring can then have two opposite ends, the inner ends of the braking shoes being attached to regions at the opposite ends at a distance of each other.

Additional objects and advantages of the invention will be set forth in the description which follows, and in part will be obvious from the description, or may be learned by practice of the invention. The objects and advantages of the invention may be realized and obtained by means of the methods, processes, instrumentalities and combinations particularly pointed out in the appended claims.

### BRIEF DESCRIPTION OF THE DRAWINGS

While the novel features of the invention are set forth with particularly in the appended claims, a complete understanding of the invention, both as to organization and content, and of the above and other features thereof may be gained from and the invention will be better appreciated from a consideration of the following detailed description of non-limiting embodiments presented hereinbelow with reference to the accompanying drawings, in which:

FIG. 1 is a front view of the inner parts of a brake in the braking state thereof, the brake being normally active and the outer braking drum and other rotating parts removed,

FIG. 2 is similar to FIG. 1 but also showing rotating parts and the brake in its non-braking state,

FIG. 3 is a sectional view of the brake of FIGS. 1 and 2 in the braking state thereof, the section taken in a plane passing magnetically permeable parts,

FIGS. 4, 5 and 6 are detail views showing gaps of the brake for the state illustrated in FIG. 2, and

FIGS. 7, 8 and 9 are similar to FIGS. 4, 5 and 6 but showing gaps of the brake for the state illustrated in FIG. 3.

### DETAILED DESCRIPTION

An electrically controlled brake for use in a motor, e.g. an electric motor or server motor, will now be described. The brake is designed so that in its braking action there is no mechanical play. This means that when the braking action is active, the object being braked cannot move or be moved, even over the smallest distance, provided of course that no exaggerated, destructing forces are applied.

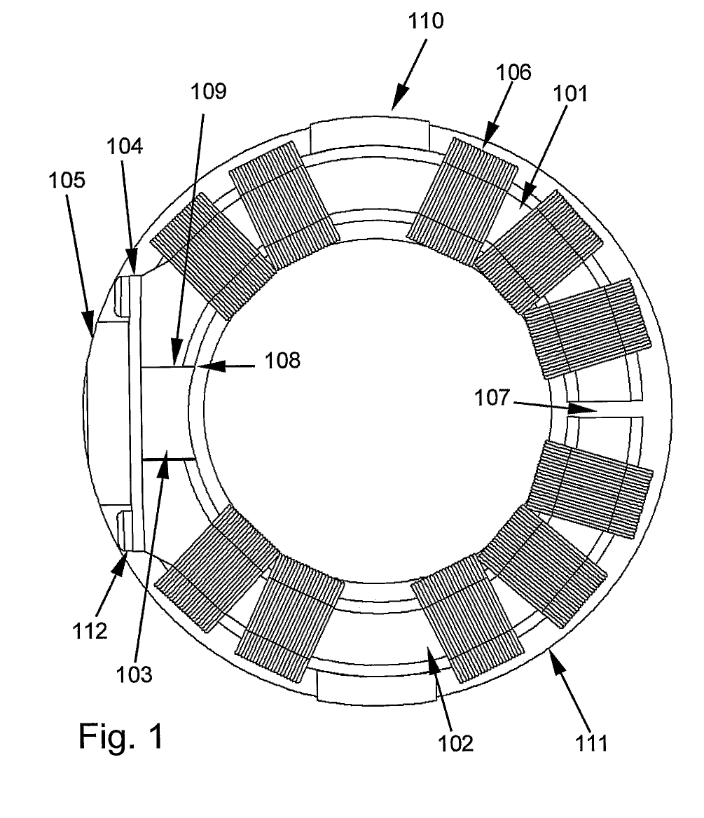

One embodiment of such a brake is illustrated in the front view of FIG. 1, the brake being normally active and the figure showing the brake in its braking state. In the embodiment shown the brake has a symmetrical structure taken about a plane extending horizontally in FIG. 1 and comprises two mechanical systems or two groups of components. The first mechanical system or group is connected to or partly included in a rotating device, for example the rotor of a motor, and is not shown in the figure. The second group is normally connected to a not rotating part or stationary part, such as a frame of the motor, and has the same function as the components shown in FIGS. 8, 9, 10 and 11 in the cited International patent application WO 2007/139480 but with a different design. In the second group there are two movable components, the brake segments or braking shoes 101 and 102, herein called half arcs, made from magnetically soft iron. Each of the movable half arcs has the general shape of substantially a half of a cylindrical ring, or more precisely a cylindrical ring segment corresponding to an angle somewhat smaller than 180° as illustrated in the figure, in the range of e.g. up to about 175°. Between first ends of the half arcs 101 and 102 a block 103 of magnetically soft iron material is located. The soft iron block has first flat surfaces at the first ends of the half arcs, the flat surfaces arranged adjacent to but generally not in contact with opposite first flat surfaces of the two half arcs. The first flat surfaces can as illustrated be parallel or nearly parallel to the mentioned symmetry plane.

A spring 104, that in the illustrated embodiment is initially flat, is rigidly attached to the three soft iron parts 101-103, i.e. to the two half arcs and the soft iron block 103, also at the first ends of the half arcs, such as to second flat surfaces located perpendicularly to the first flat surfaces. The spring 104 is also rigidly attached to a bar 105 that in turn is rigidly attached to a frame of the motor via a ring 111 located at a first, axially inner side of the half arcs 101, 102 and the block 103. In this ring one of two bearings, not shown, for the rotor of the motor for which the brake is intended can be mounted. The soft iron block 103 and the bar 105 are located on opposite sides of the spring 104 so that the portions of the spring at the end portions thereof, which are not in contact with the soft iron block but with the inner ends of the half arcs 101, 102, can elastically bend, together with the half arcs, in a direction towards the axis of the brake. The bending movement is accomplished by the fact that the free portions of the spring 104 are elastically deformed, these free portions also called bridge portions and being flexed or performing a simple bending in the movement of half arcs 101, 102.

The second, outer ends of the half arcs 101, 102 have flat surfaces that are located opposite each other and substantially parallel to each other, generally leaving a gap 107 between the flat surfaces.

In the braking state shown in FIG. 1 the spring 104 tends to press the half arcs 101, 102 outwards, away from the rotational axis of the brake, to make them come in contact with the inner cylindrical wall or surface of a rotatable hollow cylinder or rotor drum, not shown, by linings or friction parts such as 110 in a way similar to that of a conventional drum brake.

In the magnetic circuit consisting of the soft magnetic parts 101-103 there are generally three magnetic air gaps, the first air gap 107 between the second flat surfaces at the second ends of the half arcs and two small second air gaps 108 and 109 between the first flat surfaces at the first ends of the half arcs 101, 102 and the first flat surfaces of the soft iron block 103. When the brake is active and the friction parts 110 are pressing against the inner wall or surface of the rotor drum, all these air gaps are as large as possible. The second two airgaps will be almost closed when a sufficient electrical current is applied to flow in coils 106 wound around the two half arcs 101, 102, forcing the two half arcs to move, tending to close the magnetic circuit, thereby closing the larger first air gap 107. This will also release the friction parts 110 from the inner wall of the drum, thus eliminating the braking function by releasing the drum.

The width of the two second air gaps can be adjusted during assembly of the brake by pressing the two half arcs 101 and 102 together by e.g. applying a force over the two friction parts 110 so that the second air gaps are made as small as possible and the first air gap is eliminated and then tightening screws 112 attaching the first ends of the half arcs to the spring 104.

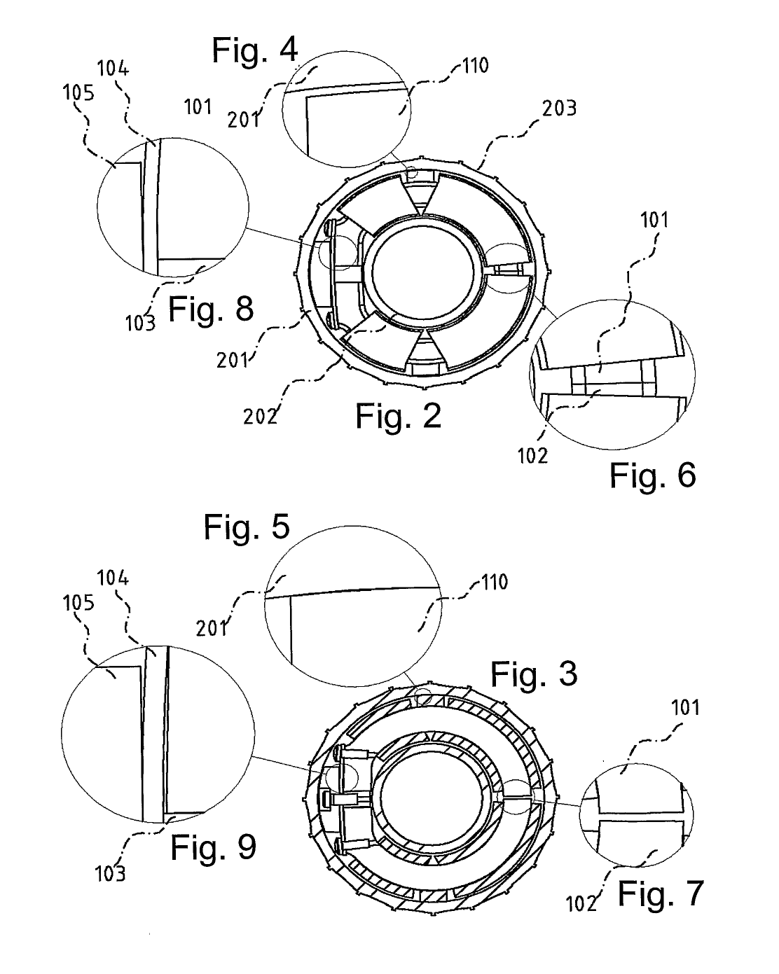

FIGS. 2 and 3 are views of a brake similar to that of FIG. 1 where the rotating components of the first group also are visible, these component also being parts of the motor, in this case an electrical motor. A motor rotor magnet holding ring 201 has shallow grooves 203 for rotor magnets, not shown, and forms the hollow drum or braking drum, radially enclosing components of the second group. Thus, it has an inner cylindrical wall against which the friction parts 110 can act. A hollow rotor shaft 202 is located radially inside the components of the second group and is concentric with and rigidly connected to the magnet carrying ring 201. FIG. 2 is a front view of the brake, seen from an outer side thereof, and FIG. 3 is a sectional view, the section taken along a plane through the soft magnetic parts 101,102 and 103.

In the view of FIG. 2 the brake is energised. As is seen in the detail view of FIG. 6, the second air gap 107 between the half arcs 101 and 102 is closed, and as a consequence thereof, the brake friction parts 110 are not in contact with the inner wall of the hollow drum 201, see the detail view of FIG. 4. The two second airgaps 108, 109 are almost or entirely closed, see the detail view of FIG. 8.

In the sectional view of FIG. 3 the brake is not energised. As is seen in the detail view of FIG. 7, the first air gap 107 between the second ends of the half arcs 101 and 102 is open. The spring 104 will try to return its original flat shape, but is stopped when the brake friction parts 110 establish contact with the inner wall of the hollow drum 201, see the detail view of FIG. 5. The spring is, as shown in the detail view of FIG. 9, a little or marginally more flat than the same spring shown for the energised case in the detail view of FIG. 8.

As is obvious for those skilled in the art, the invention shown can be varied in many ways. For example, only one movable braking shoe such as 101 may be arranged, the other braking shoe replaced with a stationary component having the same basic design at the braking shoe but without a friction lining.

While specific embodiments of the invention have been illustrated and described herein, it is realized that numerous other embodiments may be envisaged and that numerous additional advantages, modifications and changes will readily occur to those skilled in the art without departing from the spirit and scope of the invention. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention. Numerous other embodiments may be envisaged without departing from the spirit and scope of the invention.

1. An electrically controlled brake comprising
a rotatable first mechanical system rotatable about a rotational axis and including a braking drum having an inner cylindrical wall or surface; and
a second mechanical system further comprising:
at least one winding to which a control electric current can be applied;
at least one movable braking shoe having a friction part for acting against or for engagement with said inner cylindrical wall or surface, the at least one movable braking shoe made from magnetically soft iron material and arranged so that electric current flowing in the at least one winding affects magnetic fluxes through the at least one movable braking shoe causes attraction forces over a first air gap tending to move the at least one braking shoe to reduce the width of the air gap; and
at least one spring, creating elastic forces on the at least one movable braking shoe, the elastic forces acting in a direction substantially opposing said attraction forces created by an electrical current flowing in the at least one winding, the elastic forces tending to move the at least one movable braking shoe to bring its friction part in engagement with said inner cylindrical wall or surface of the braking drum and the attraction forces tending to move the at least one movable braking shoe to bring its friction part out of engagement with said inner cylindrical wall or surface, wherein the at least one spring is mounted at an inner end of the at least one movable braking shoe and that the first air gap is located at an outer, opposite end of the at least one movable braking shoe.

2. An electrically controlled brake according to claim 1, wherein the spring is rigidly attached to the inner end of the at least one movable braking shoe, the spring and the at least one movable braking shoe thereby forming a unified structure, a bridge portion of the spring being flexed or performing a simple bending movement when the at least one movable braking shoe moves.

3. An electrically controlled brake according to claim 1, wherein two movable braking shoes are arranged and that the first air gap is located at outer ends of the two braking shoes, the spring being rigidly attached to inner ends of the two movable braking shoes, the spring and the two movable braking shoes thereby forming a unified, generally C-shaped structure.

4. An electrically controlled brake according to claim 3, wherein the spring forms a bridge between the inner ends of the two movable braking shoes, bridge portions of the spring being located between said inner ends and being flexed or performing a simple bending movement when the two movable braking shoes move.

5. An electrically controlled brake according to claim 3, wherein the spring has an inner surface to which the two movable braking shoes are rigidly attached.

6. An electrically controlled brake according to claim 5, wherein the spring has an outer surface that is located opposite the inner surface and is rigidly connected to a stationary frame.

7. An electrically controlled brake according to claim 1, wherein the spring has a substantially flat shape.

8. An electrically controlled brake according to claim 3, comprising a block made from magnetically soft iron material and located between the inner ends of the two movable braking shoes, the block being part of a magnetically closed path also passing the two braking shoes and the first air gap when an electric current is flowing in the at least one winding.

9. An electrically controlled brake according to claim 8, wherein the spring has an inner surface to which the two movable braking shoes and the soft iron block are rigidly attached.

10. An electrically controlled brake according to claim 9, wherein the two movable braking shoes and the soft iron block are mounted to the surface of the spring leaving second air gaps between opposite surfaces of the two braking shoes and the soft iron block when the spring is in a relaxed state or in a not elastically deformed state, the magnetically closed path also passing the two second air gaps when an electric current is flowing in the at least one winding.

11. An electrically controlled brake according to claim 10, wherein the bridge portion of the spring includes two separate sections, each of the two separate sections corresponding to and located at one of said two second air gaps.

12. An electrically controlled brake according to claim 1, wherein the braking drum is part of a rotor of an electric motor.
